(19) United States
(12) Patent Application Publication
(10) Pub. No.: US 2017/0213217 A1
(43) Pub. Date: Jul. 27, 2017

(54) SERVICE MANAGEMENT METHOD

(71) Applicant: MSC CONSULTING (S) PTE LTD, Singapore (SG)

(72) Inventor: KIAN HWA GOH, Singapore (SG)

(21) Appl. No.: 15/326,629

(22) PCT Filed: Jul. 3, 2015
(86) PCT No.: PCT/SG2015/050197

§ 371 Date: Jan. 16, 2017

(30) Foreign Application Priority Data
Jul. 16, 2014 (SG) 10201404112W

(51) Int. Cl. G06Q 20/40

(52) U.S. Cl. CPC G06Q 20/405

(57) ABSTRACT

Described herein is disclosed a service management method comprising receiving a transaction request from a user computing device with the transaction request. The method further comprises authenticating the transaction request before transmitting the transaction request and a service identifier to a service computing system associated with the identified one of the plurality of service accounts for procuring a transaction response.

### TECHNICAL FIELD

This invention relates generally to a computer-implemented method for business-to-business (B2B) service management.

### BACKGROUND

Third-party business-to-business (B2B) gateways and integration platforms have emerged to reduce the costs of adapting and integrating transactional, enterprise services across trading partners. Because applications of trading partners are built independently, they face a complex integration challenges when opening up to business networks. Attention is turning to smaller enterprises and how they can leverage on marketplaces/hubs, cloud computing and/or mobile technologies. Therefore, there exists a need for easily implementable and substantially adaptive methods, systems and frameworks for smaller enterprises to offer, deploy and procure B2B services. Further, methods, systems and frameworks will enable integration with external and/or back-end services, for example resource planning services and software, in order to enhance the decision making quality and other aspects of business processes. Having integration with such services can drastically reduce overhead and increase efficiencies in line-of-business activities.

### SUMMARY

In accordance with a first aspect of the invention, there is disclosed a service management method comprising receiving a transaction request from a user computing device with the transaction request comprising transaction data and token data. The method further comprises authenticating the token data and identifying one of a plurality of service accounts associated with the token data. Each of the plurality of service account has a service identifier associated therewith. The transaction request and the service identifier are then transmitted to a service computing system associated with the identified one of the plurality of service accounts.

The service identifier is for authentication by the service computing system associated with the identified one of the plurality of service accounts. The method further comprises receiving transaction response from the service computing system associated with the identified one of the plurality of service accounts in response to the transaction request, wherein the transaction response is for provision to the user computing device.

In accordance with a second aspect of the invention, there is disclosed a machine-readable medium having stored therein a plurality of programming instructions, which when executed, the instructions cause the machine to receive a transaction request from a user computing device with the transaction request comprising transaction data and token data; authenticate the token data and identifying one of a plurality of service accounts associated with the token data with each of the plurality of service account having a service identifier associated therewith; transmit the transaction request and the service identifier to a service computing system associated with the identified one of the plurality of service accounts with the service identifier for authentication by the service computing system associated with the identified one of the plurality of service accounts; and receive transaction response from the service computing system associated with the identified one of the plurality of service accounts in response to the transaction request. The transaction response is for provision to the user computing device.

### BRIEF DESCRIPTION OF THE DRAWINGS

FIG. 1 shows a system diagram of a a agement system in accordance with an aspect of the invention; and

FIG. 2 shows a data flow diagram of the service management system of FIG. 1; and

FIG. 3 shows a process flow diagram of a service management method in accordance with an aspect of the invention for implementation by the service management system of FIG. 1.

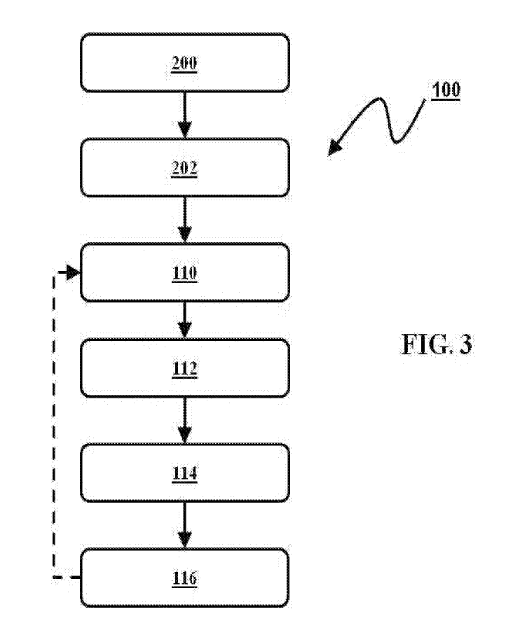

### DETAILED DESCRIPTION

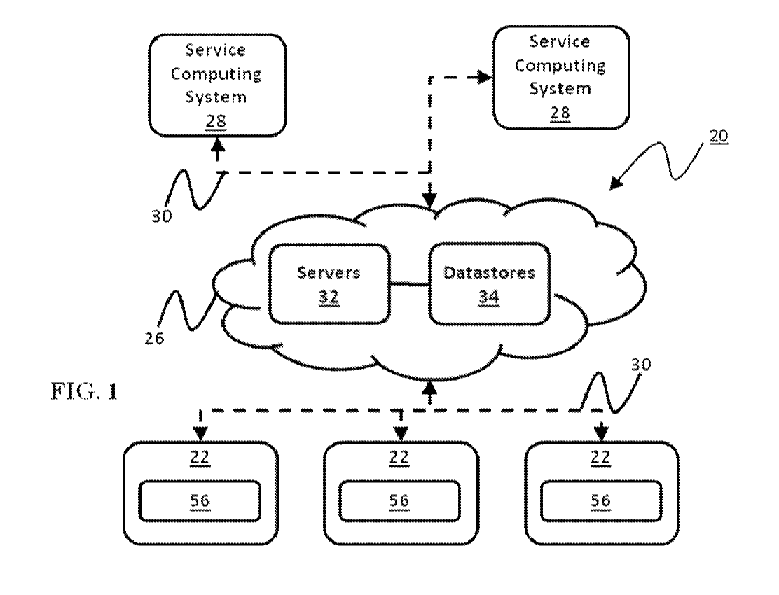

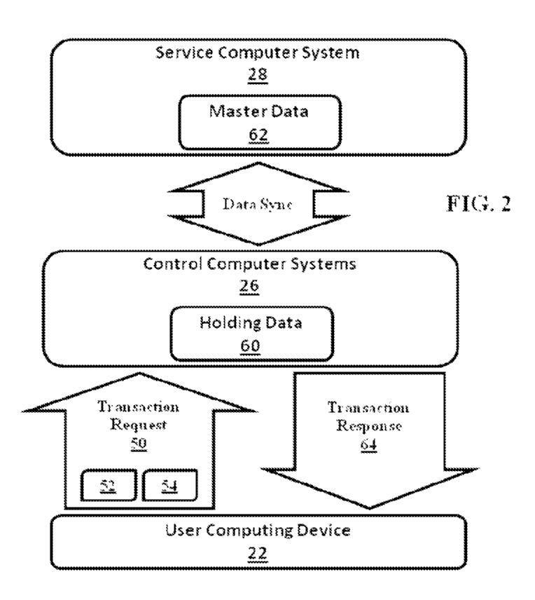

An exemplary embodiment of the present invention, a service management method 100 utilising a service management system 20, is described hereinafter with reference to FIG. 1 and FIG. 2.

Implementations of the present disclosure are generally directed to the service management method 100 and an associated system to provide a comprehensive platform to facilitate delivery of services from business-to-business (B2B). The business-to-business applies also to individuals requiring operating in a business framework. The services provided can be adapted through a choice of B2B gateway services. The services can he aggregated by and channeled through third-parties.

Implementations of the service management method 100 support diversified business possibilities and service delivery between businesses facilitated by best-of-breed platform of the service management system 20. The service management method sets the stage for the next service-oriented revolution, referred variously as service ecosystems, future business value networks, and other forms of hubs and communities, underpinned by an Internet-scale infrastructure, to provide a level playing field for supply and demand of services on over the Internet across a multitude of devices and computing system.

FIG. 1 depicts an exemplary system architecture of the service management system 20 that can execute implementations of the present disclosure. The service management system 20 can include a user computing device 22 associated with a user, control computer systems 26 and a service computing system 28. The user computing device 22 can communicate with one or more of the control computer systems 26 over a network 28. The control computer systems 26 can communicate with each other and/or the user computing device 2.2 and the service computing system 28 over a network 30. The control computer systems 26 can each include one or more servers 32 and one or more datastores 34, respectively. In some implementations, the service management system 20 may represent a client/server system supporting multiple computer systems (e.g., control computer systems 26) including one or more clients (e.g., user computing device 22 and service computing system 28) that are connectively coupled for communication with one another over the network 30.

The user computing device 22 can represent various forms of processing devices including, but not limited to, a desktop computer, a laptop computer, a handheld computer, a personal digital assistant (PDA), a sniartphone, a smart tablet, a cellular telephone, a network appliance, a camera, a smart phone, an enhanced general packet radio service (EGPRS) mobile phone, a media player, a navigation device, an email device, a game console, or a combination of any two or more of these data processing devices or other data processing devices, The user computing device 22 may access application software on one or more of the control computer systems 26.

The control computer systems 26 can represent various forms of server systems including, but not limited to a web server, an application server, a proxy server, a network server, or a server farm. For example, one or more of the servers 32 can be an application server that executes software accessed by the user computing device 22. In some implementations, a user can invoke applications available on one or more of the servers 32 in a web browser or a mobile application running on a client (e.g., user computing device 22). Each application can individually access data from one or more repository resources (e.g., datastores 112).

In some implementations, the user computing device 22 and the service computing system 28 may communicate wirelessly through a communication interface (not shown), which may include digital signal processing circuitry where necessary. The communication interface may provide for communications under various modes or protocols, such as Global System for Mobile communication (GSM) voice calls, Short Message Service (SMS), Enhanced Messaging Service (EMS), or Multimedia. Messaging Service (MMS) messaging, Code Division Multiple Access (CDMA), Time Division Multiple Access (TDMA), Personal Digital Cellular (PDC), Wideband Code Division Multiple Access (WCDMA), CDMA2000 or General Packet Radio System (CPRS), among others. For example, the communication may occur through a radio-frequency transceiver (not shown). In addition, short-range communication may occur, such as using a Bluetooth, or other such transceiver.

The network 30 can be a large computer network, such as a local area network (LAN), wide area network (WAN), the Internet, a cellular network, or a combination thereof connecting any number of mobile clients, fixed clients, and/or servers. In some implementations, each client (e.g., user computing device 22) can communicate with one or more of the control computer systems 26 via a virtual private network (VPN), Secure Shell (SSH) tunnel, or other secure network connection. In some implementations, the network 30 can include the Internet, a wireless service network and may include the Public Switched Telephone Network (PSTN). In other implementations, the network 30 may include a corporate network (e.g., an intranet) and one or more wireless access points.

The user computing device 22 can establish its own session with the control computer systems 26. Each session can involve two-way information exchange between the control computer systems 26 and the user computing device 22. For example, a Hypertext Transfer Protocol (HTTP) session can allow the association of information with individual users. A session can be stateful session, in which at least one of the communicating parts (e.g., the control computer systems 26 or the user computing device 22) stores information about the session history in order to be able to communicate. Alternatively, stateless communication during a stateless session includes independent requests with associated responses.

The service management method 100 comprises receiving a transaction request 50 from the user computing device 22 in a step 110. Preferably, the transaction request 50 comprises transaction data 52 and token data 54. Preferably, the transaction request 50 is generated by the user computing device 22 providing a user interface (UI) instance for capturing inputs from the user when the user interacts with the user computing device, via the UI thereof.

A service application 56, either in the form of a mobile/device-based application residing on the user computing device 22, as a web-based application residing on the control computer systems 26 accessible via a web browser of the user computing device 22 or as a hybrid mobile application runs inside of a native container on the user computing device 22 and leverages the user computing device's 22 web browser to display locally hosted HTML pages. The service application 56 can be specific to a service computing system 28 associated with a particular service provider or a generalized application for accessing multiple service computing systems 28 across multiple service providers.

Upon initiation of the service application 56 on the user computing system 22 in a step 200, the service application 56 may require the provision of a user identifier and authentication data. The authentication data can be one or a combination or a password, a hardware key or biometric data captured from the user by the user computing device 22. Alternatively, a device code unique to and providable by the user computing device 22 may be used to replace solely the user identifier or both the user identifier and the authentication data.

The user identifier and the authentication data are then received by the control computer systems 26 for identifying one of a plurality of service accounts which is uniquely indicative of the user computing device 22 and services providable by the service provider associated with the service computing system 28. For clarity, a service provider associated with the service computing system 28 may provide services to multiple user computing devices 22 via the control computer systems 26 using the service management method 100.

Once the specific one of the plurality of service accounts has been identified from the user identifier and authenticated using the authentication data by one or both of the control computer systems 26 and the service computing system 28, the token data 54 is generated between the user computing device 22 and the control computer systems 26 for establishing a transaction session in a step 202.

Upon the transaction session being established between the user computing device 22 and the control computer systems 26, a request for available services may be made in the step 110. The transaction data 52 for the request for available services may be automatically generated by the service application 56 upon initiation thereof for provision to the control computer systems in the step 110.

Preferably, the datastores 34 of the control computer systems 26 contains holding data 60. The holding data 60 comprises service-side data descriptive of, for example, the services providable by a service provider including availability, quantity, specification, cost, delivery scheduling and related retail and inventory information of products and/or services providable by the service provider associated with the service computing system 28. The holding data 60 further comprises user-side data indicative of service acquisition and booking information, service fulfillment and transactional history related to each of the plurality of service accounts. The service computing system 28 can be a resource planning system, for example an enterprise resource planning (ERP) system, containing master data 62. Hence, it is preferred that the holding data 60 be synced with the master data 62 at predetermined time intervals or in accordance with a syncing schedule in transactional real-time.

Once the transaction request 50 is received in the step 110, the transaction request is authenticated by the control computer systems 26 in a step 112. Depending on implementation, the transaction request 50 may be processed by the control computer systems 26 or be processed by the service computing system 28 in tandem with or prior to the holding data 60 being synced with the master data 62 in a step 114. Alternatively in other implementations, the transaction request 50 is processed by the service computing system 28 in the absence or presence of the holding data 60 with the control computer systems 26 functioning only to convey the transaction request 50 and subsequently the transaction response 64 generated by the control computer systems 26. During data syncing of the holding data 60 with the master data 62, a service identifier 66 associated with the identified one of the plurality of service accounts may be shared by the control computer systems with the service computing system 28. This is to ensure that correct corresponding portion of the master data 62 is synced with the updated portion of the holding data 60 associated with identified one of the plurality of service accounts.

Alternatively or in addition, the transaction data 52 of the transaction request 50 may be processed prior to transmission thereof to the service computing system to comply with at least one of data formatting and data parameter requirements of a service application operating on the service computing system 28 for performing the transaction request 50 thereon.

Next, a transaction response 64 is generated for provision by the control computer systems 26 to the user computing device 22 in a step 116. Depending on implementation and the nature of the transaction request 50, the transaction response 64 may either be generated by the control computer systems 26 or the service computing system.

If the transaction request 50 is related to the request for available service, the transaction response 64 will contain response data 66 descriptive and/or indicative of the available services obtained from the holding data 60 or the master data 62.

The nature of the transaction request 50 is varied and extends from requests for available services, requests for acquisition or reservation of services, goods or products, requests for cancellation of acquisition or reservation, request for delivery and pending delivery information to requests for transactional history relating to a the identified one of the plurality of service accounts.

Besides basic transactional, updating and informational request operations, the control computer systems 26 can also perform processing of transactional data 52 replicating or adding to the capabilities of the service computing system 28. Further, as the real-time syncing requirement between the holding data 60 and the master data 62 is dependent on the state of the network 30, there are instances where real-time syncing may not be possible for an undefined duration. As the service computing system 28 may also be accessed and updated on-site, transactions occurring with the holding data 60 may conflict with updates to and/or transactions occurring on-site of the service computing system 28 with the master data 62. In such a situation, the control computing Systems 32 may impose certain conditions on the transaction request 50 received from the user computing device 22. For example, if X number of items exists in the inventory before syncing between the holding data 60 and the master data 62 was terminated, the control computer system 26 implementing the service management method 100 may only allow transaction requests 50 purchasing up to a pre-defined percentage, for example 50% of X, before disallowing purchases until syncing between the holding data 60 and the master data 62 has been restored. Hence, the transaction response 64 can also be indicative of success or failure of a transaction requested for in the form of the transaction request 50.

For clarity, the transaction response 64 is providable to the user computing device 22 and comprises output, or output data, generated from performing the transaction request 50 by the service computing system 28 and/or the control computer systems. The output data is presentable on the user computing device 22 for enabling at least one of interaction therewith and selection thereof by the user of the user computing device 22.

Hence, as aforedescribed, the service management method 100 enables a platform to be established for facilitating access to services between business and individuals via the service management system 20, specifically the control computer systems 26. The control computer systems 26 may employ a variety of APIs and interface modules to work with the various software application and software platforms employed by different service providers on their service computer system 28. This readily enables access of the services provided by the service computing system 28 through the control computer systems 26 without need to cater for multiple user access to the service computing system 28. As the software platform or software application, for example an ERP product, operating on the service computing system 28 may have an established limitation on the number of separate user access thereto, employing the service management method 100 results in only one or few defined user access, and hence user account, between the control computer systems 26 and the service computing system 28. Further, the control computer systems 26 functions as a load manager and buffers the service computing system 28 from load discrepancies, fluctuations and peaks.

The control computer systems 26 also enables web, wireless and mobile access, especially when employing smart devices like tablets, to the services of the availed via the service computing system 28. The readily device-compliant service application 56 enables seamless access via the user computing device 22 especially for users who are not or have little technology saviness.

In an exampiary utilisation of the service management method 100, the service provider is a supplier of fast moving consumer goods (FMCG) to a variety of business clients including food stall operators. A first client wishes to place an order for a list of FMCG items providable by the service provider. The first client operates his smart tablet-based user computing device 22 via the UI thereof to initiate the service application 56 thereon in the step 200. As the first client has pre-registered with the service provider, he proceeds to input his user identifier unique thereto with the associated password as the authentication data. These are then sent by the user computing device 22 of the first client to the control computer systems 26 for login authentication. Once the provided authentication data has been verified by the control computer systems 26, a transaction session is established between the user computing device 22 of the first client and the control computer systems 26 with token data being generated for provision to the user computing device 22 in the step 202. The first client then interacts with the user computing device 22 to request for a list of FMCG items available for purchase from the service provider in the form of the transaction request 50. The transaction request 50 will contain the generated token data 54 which will be sent to the control computer systems 26 in the step 110. The control computer systems 26 will authenticate the token data 52 in the step 112 before processing the transaction request 50 in the step 114. The transaction data 52 at this point contains indication for listing of available FMCG items to be provided. The control computer systems 26, having synced the holding data 60 with the master data 62 in parallel, will extract the necessary information on the available FMCG items from the holding data 60 before providing the information to the user computing device 22 in the form of the transaction response 64 in the step 116.

After view the listing of the available FMCG items, the first client may make selection the FMCG items required, including the quantity required and the like related parameters, before submitting the purchase request as the transaction request 50 in the step 110. The control computer systems 26 then progresses through step 112 and step 114 before providing a reply of successful purchase in the form of the transaction response 64 in the step 116. The first user can continue to sequentially provide the transaction request 50 to urge the transaction response 64 thereto until the first client logs off from or closes the service application 56.

While the first client is procuring transactions from the service provider, a second client can be procuring transactions relating to checking delivery status of FMCG items previously purchased from the service provider and review transactional history through steps 110 to 116 in the form of the transaction request 50 and associated transaction response 64 using the user computing device 22 of the second client. The first client will have one of the plurality of service accounts associated therewith while the second client will have another of the plurality of service accounts associated therewith. This is made possible by the use of different user identifiers which in turn with generate uniquely different token data for establishing different transaction sessions between the control computer systems 26 and user computing device 22 of each of the first client and the second client. The different service accounts for the first client and the second client ensures proper segregation and distinction of portions of the holding data 60 and the master data 62 even though updates and transaction requests 50 affecting the holding data 60 effected in tandem by the first client and the second client can be synced at the same time or instance with the master data 62.

Aspects of particular embodiments of the present disclosure address at least one aspect, problem, limitation, and/or disadvantage associated with existing computer-implemented methods and systems. While features, aspects, and/or advantages associated with certain embodiments have been described in the disclosure, other embodiments may also exhibit such features, aspects, and/or advantages, and not all embodiments need necessarily exhibit such features, aspects, and/or advantages to fall within the scope of the disclosure. It will be appreciated by a person of ordinary skill in the art that several of the above-disclosed structures, components, or alternatives thereof, can be desirably combined into alternative structures, components, and/or applications. In addition, various modifications, alterations, and/or improvements may be made to various embodiments that are disclosed by a person of ordinary skill in the art within the scope of the present disclosure, which is limited only by the following claims.

1. A service management method comprising:
receiving a transaction request from a user computing device, the transaction request comprising transaction data and token data;
authenticating the token data and identifying one of a plurality of service accounts associated with the token data, each of the plurality of service account having a service identifier associated therewith;
transmitting the transaction request and the service identifier to a service computing system associated with the identified one of the plurality of service accounts, the service identifier for authentication by the service computing system associated with the identified one of the plurality of service accounts; and
receiving transaction response from the service computing system associated with the identified one of the plurality of service accounts in response to the transaction request,
wherein the transaction response is for provision to the user computing device.

2. The service management method as in claim 1, further comprising:
providing the transaction response to the user computing device.

3. The service management method as in claim 1, the transaction response being indicative of one of success and failure of performance of the transaction request by the service computing system.

4. The service management method as in claim 1, the transaction response comprising output data generated from performing the transaction request by the service computing system.

5. The service management method as in claim 4, the output data being presentable on the user computing device for enabling at least one of interaction therewith and selection thereof by a user of the user computing device.

6. The service management method as in claim 1, further comprising:
processing the transaction data prior to transmission thereof to the service computing system, the transaction data being process to comply with at least one of data formatting and data parameter requirements of a service application operating on the service computing system, the service application for performing the transaction request on the service computing system.

7. The service management method as in claim 1, further comprising:
updating a database associated with the identified one of the plurality of service account with the transaction data.

8. The service management method as in claim 1, updating a database associated with the identified one of the plurality of service account with the transaction data comprising:
processing the transaction data for updating the database associated with the identified one of the plurality of service account, the processed transaction data further for transmission to the service computer system.

9. The service management method as in claim 1, further comprising:
providing service data to a user application operating on the user computing device, the user application for adapting an interface on the user computing device for receiving user input thereby.

10. The service management method as in claim 9, the user application being service-specific to the identified one of the plurality of service accounts.

11. The service management method as in claim 9, the service computing system being a smart mobile device and the user application being a mobile application.

12. A machine-readable medium having stored therein a plurality of programming instructions, which when executed, the instructions cause the machine to:
receive a transaction request from a user computing device, the transaction request comprising transaction data and token data;
authenticate the token data and identifying one of a plurality of service accounts associated with the token data, each of the plurality of service account having a service identifier associated therewith;
transmit the transaction request and the service identifier to a service computing system associated with the identified one of the plurality of service accounts, the service identifier for authentication by the service computing system associated with the identified one of the plurality of service accounts; and
receive transaction response from the service computing system associated with the identified one of the plurality of service accounts in response to the transaction request,
wherein the transaction response is for provision to the user computing device.

13. The machine-readable medium as in claim 12, wherein the plurality of programming instructions, which when executed, the instructions further cause the machine to:
providing the transaction response to the user computing device.

14. The machine-readable medium as in claim 12, wherein the transaction response being indicative of one of success and failure of performance of the transaction request by the service computing system.

15. The machine-readable medium as in claim 12, wherein the transaction response comprising output data generated from performing the transaction request by the service computing system.

16. The machine-readable medium as in claim 15, wherein the output data being presentable on the user computing device for enabling at least one of interaction therewith and selection thereof by a user of the user computing device.

17. The machine-readable medium as in claim 12, wherein the plurality of programming instructions, which when executed, the instructions further cause the machine to:
process the transaction data prior to transmission thereof to the service computing system, the transaction data being process to comply with at least one of data formatting and data parameter requirements of a service application operating on the service computing system, the service application for performing the transaction request on the service computing system.

18. The machine-readable medium as in claim 12, wherein the plurality of programming instructions, which when executed, the instructions further cause the machine to:
provide service data to a user application operating on the user computing device, the user application for adapting an interface on the user computing device for receiving user input thereby.

19. The machine-readable medium as in claim 18, the user application being service-specific to the identified one of the plurality of service accounts and the service computing system being a smart mobile device and the user application being a mobile application.

20. The machine-readable medium as in claim 12, wherein the plurality of programming instructions, which when executed, the instructions further cause the machine to:
process the transaction data for updating the database associated with the identified one of the plurality of service account; and
update a database associated with the identified one of the plurality of service account with the transaction data, the processed transaction data further for transmission to the service computer system.
